(19) United States
(12) Patent Application Publication
(10) Pub. No.: US 2016/0365203 A1
(43) Pub. Date: Dec. 15, 2016

(54) PUSH BUTTON AND ELECTRONIC APPARATUS INCLUDING PUSH BUTTON

(71) Applicant: SEIKO EPSON CORPORATION, Tokyo (JP)

(72) Inventor: Yoshihiro HIDAI, Shiojiri-shi (JP)

(73) Assignee: SEIKO EPSON CORPORATION, Tokyo (JP)

(21) Appl. No.: 15/179,996

(22) Filed: Jun. 11, 2016

(30) Foreign Application Priority Data
Jun. 12, 2015 (JP) 2015-119043

(51) Int. Cl. H01H 13/14; G05G 5/05; G04B 37/12; G05G 1/02

(52) U.S. Cl. CPC H01H 13/14; G05G 1/025; G05G 5/05; G04B 37/12; H01H 2235/01; H01H 2231/028

(57) ABSTRACT

A push button includes an operation body having a first surface, a lid body including a lid section, a reception section so disposed to be more remote from the first surface than the lid section, and a trunk section that connects the lid section and the reception section to each other, and a spring that is disposed between the operation body and the lid body and has one end and another end in a direction that intersects the first surface of the operation body with the one end in contact with the reception section and the other end in contact with the first surface.

### CROSS-REFERENCE

This application claims priority to Japanese Patent Application No. 2015-119043, filed Jun, 12, 2015, the entirety of which is hereby incorporated by reference.

### BACKGROUND

### 1. Technical Field

The present invention relates to a push button and an electronic apparatus including the push button.

### 2. Related Art

A push button structure for an electronic apparatus has been proposed (see JP-A-2002-352662). According to the push button structure described in JP-A-2002-352662, however, the configuration in which an elastic member is also used as a gasket results in low sealability and small urging force.

It is preferable that a push button has a small amount of protrusion from a main body.

### SUMMARY

An advantage of some aspects of the invention is to provide a novel push button having a small amount of protrusion from a main body. Another advantage of some aspects of the invention is to provide a novel electronic apparatus including the push button having a small amount of protrusion from a main body.

### APPLICATION EXAMPLE 1

A push button according to this application example of the invention includes an operation body having a first surface, a lid body including a lid section, a reception section so disposed to be more remote from the first surface than the lid section, and a trunk section that connects the lid section and the reception section to each other, and a spring that is disposed between the operation body and the lid body and has one end and another end in a direction that intersects the first surface of the operation body with the one end in contact with the reception section and the other end in contact with the first surface.

In the push button according to this application example, since the reception section of the lid body is so disposed to be more remote from the first surface of the operation body than the lid section and is in contact with one end of the spring, the amount of protrusion, from a main body of an apparatus, of the push button assembled in the main body can be reduced, as compared, for example, with a case in which the one end of the spring is in contact with the lid section.

### APPLICATION EXAMPLE 2

In the push button according to the application example of the invention, the operation body may include a wall section that surrounds the first surface.

In the push button according to this application example, the operation body includes the wall section that surrounds at least part of the first surface. The positional relationship between the spring and the operation body in the direction that intersects the first surface is therefore stably kept, whereby the operation body is likely to be stably held.

### APPLICATION EXAMPLE 3

The push button according to the application example of the invention may further include a shaft having a longitudinal direction that coincides with the intersecting direction, and the spring may be a coil spring that surrounds the shaft, and the lid body may be an annular body that surrounds the shaft when viewed in the longitudinal direction.

In the push button according to this application example, since the annular lid body and the coil spring are so disposed as to surround the shaft, the operation body and the shaft can be stably held.

### APPLICATION EXAMPLE 4

An electronic apparatus according to this application example of the invention includes a push button including an operation body having a first surface, a lid body including a lid section, a reception section, and a trunk section that connects the lid section and the reception section to each other, and a spring that is disposed between the operation body and the lid body and has one end and another end in a direction that intersects the first surface of the operation body with the one end in contact with the reception section and the other end in contact with the first surface.

In the electronic apparatus according to this application example, since the reception section of the lid body is so disposed to be more remote from the first surface of the operation body than the lid section and is in contact with one end of the spring, the amount of protrusion, from a main body of an apparatus, of the push button assembled in the main body can be reduced, as compared, for example, with a case in which the one end of the spring is in contact with the lid section.

### BRIEF DESCRIPTION OF THE DRAWINGS

The invention will be described with reference to the accompanying drawings, wherein like numbers reference like elements.

FIG. 1 is a front view of an electronic apparatus according to an embodiment.

FIG. 2 is a cross-sectional view of a push button according to the embodiment taken along the line X-X in FIG. 1.

FIG. 3 is a cross-sectional view of a push button according to related art.

FIG. 4 is a cross-sectional view of a push button according to Variation 1 taken along the line X-X in FIG. 1.

FIG. 5 is a cross-sectional view of a push button according to Variation 2 taken along the line X-X in FIG. 1.

FIG. 6 is a cross-sectional view of a push button according to Variation 3 taken along the line X-X in FIG. 1.

### DESCRIPTION OF EXEMPLARY EMBODIMENTS

A preferable embodiment of the invention will be described below in detail with reference to the drawings. It is not intended that the embodiment described below unduly limits the contents of the invention set forth in the appended claims. Further, all configurations described below are not necessarily essential configuration requirements of the invention.

A push button according to the present embodiment includes an operation body having a first surface; a lid body including a lid section, a reception section so disposed to be more remote from the first surface than the lid section, and a trunk section that connects the lid section and the reception section to each other; and a spring that is disposed between the operation body and the lid body and has one end and another end in a direction that intersects the first surface of the operation body with the one end in contact with the reception section and the other end in contact with the first surface.

An electronic apparatus according to the present embodiment is an electronic apparatus including a main body and the push button described above.

### 1. Outline of Electronic Apparatus

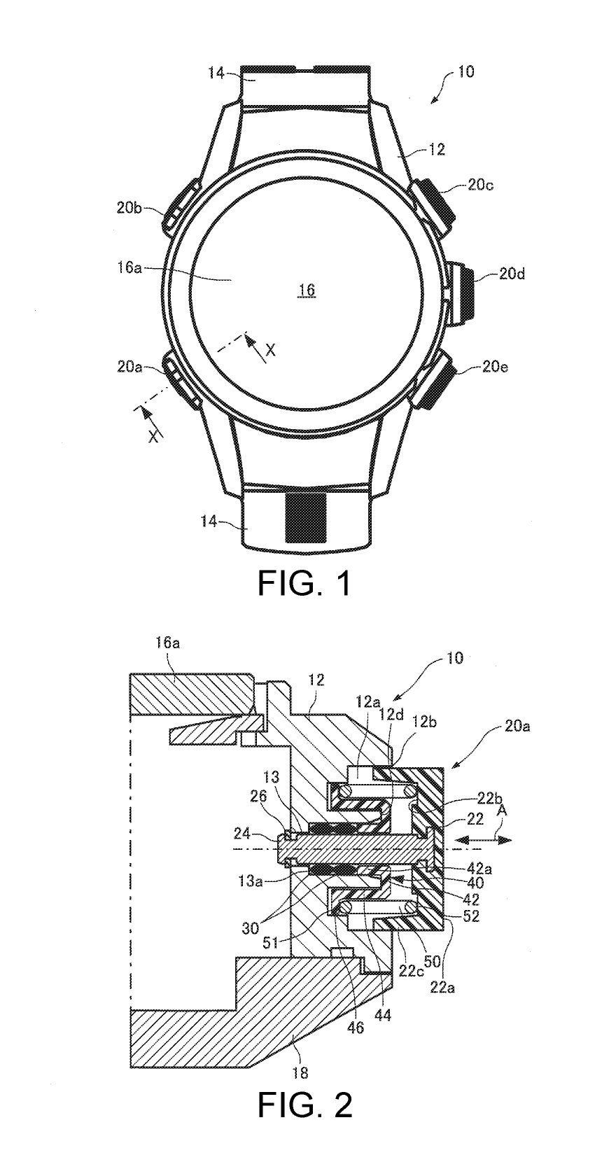

A summary of an electronic apparatus 10 according to the present embodiment will first be described with reference to FIGS. 1 and 2. FIG. 1 is a front view of the electronic apparatus 10 according to the embodiment, and FIG. 2 is a cross-sectional view of a push button 20a according to the embodiment taken along the line X-X in FIG. 1.

The electronic apparatus 10 shown in FIG. 1 includes a main body 12 and five push buttons 20a, 20b, 20c, 20d, and 20e. The electronic apparatus 10 further includes belts 14, which are connected to opposite ends of the main body 12 and allowed to be wound around a user's arm, a display section 16, which displays the content of an output from the electronic apparatus 10, and an electric circuit and other components that are not shown but are present inside the main body 12. The electronic apparatus 10 may be a wristwatch.

The main body 12, along with a cover glass plate 16a provided on the side facing the display section 16 and a case back 18 (FIG. 2) facing away from the cover glass plate 16a, forms an enclosure of the electronic apparatus, and the enclosure accommodates the electric circuit and other components. The main body 12 can be made of a metal material, such as stainless steel, a titanium-based alloy, and a gold alloy, or a plastic material, such as polycarbonate and ABS.

The main body 12 has a recess 12a, which is formed in the side surface of the main body 12 and has an opening 12b, and a through hole 13, as shown in FIG. 2. A shaft 24 of the pushbutton 20a passes through the through hole 13. Two annular gaskets 30 are disposed in the gap as between the through hole 13 and the shaft 24 an accommodation chamber (gasket box) 113a along a protruding/retracting direction A.

The push buttons 20a, 20b, 20c, 20d, and 20e are so disposed that two of them are disposed on one side of the belts 14 (for example, on the side facing 9 o'clock assuming that a dial of an analog timepiece is used) and the other three are disposed on the other side of the belts 14 (for example, on the side facing 3 o'clock assuming that a dial of an analog timepiece is used). The push buttons 20a, 20b, 20c, 20d, and 20e slightly protrude from the side surface of the main body 12 and are allowed to be pushed by the user into the recess 12a provided in the main body 12. The push buttons 20a, 20b, 20c, 20d, and 20e are intended for the user's operation of the electronic apparatus 10. For example, when any of the push buttons 20a, 20b, 20c, 20d, and 20e is pushed, the front end of the push button directly or indirectly access the electric circuit or any other component accommodated in the main body 12.

The electric circuit that is not shown includes, for example, a processor formed, for example, of a GPS (global positioning system) unit having the function of a GPS receiver, a CPU (central processing unit), a DSP (digital signal processor), and an ASIC (application specific integrated circuit); a storage formed, for example, of a variety of IC memories, such as a ROM (read only memory), a flash ROM, and a RAM (random access memory), and recording media, such as a hard disk drive and a memory card; a time measurement section that generates time information; a display section that displays image data, text data, and other types of data transmitted from the processor; a sound output section that outputs sound data transmitted from the processor in the form of voice, buzzer sound, or any other sound; and a communication section that communicates with an external apparatus (for example, smartphone, tablet PC (personal computer), notebook PC, and desktop PC) and forwards a variety of types of information (for example, positioning data, accumulated travel distance, movement path, and other types of information) generated by the processor to the external apparatus.

### 2. Push Button

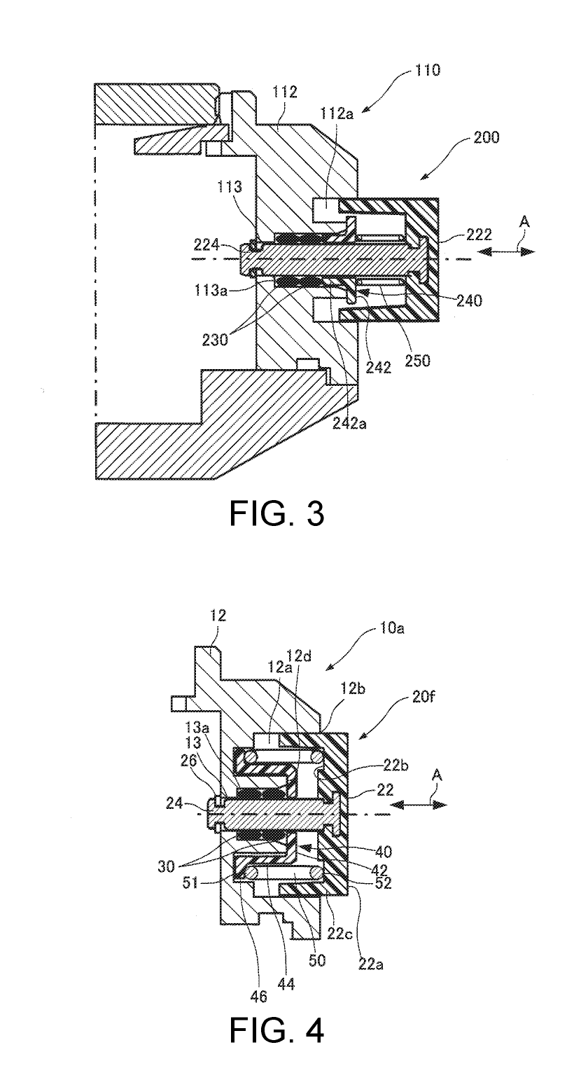

A detailed structure of the push button 20a will be described with reference to FIG. 2 after a push button 200 according to related art shown in FIG. 3 is described.

### 2-1. Push Button of Related Art

FIG. 3 is a cross-sectional view of the push button 200 according to related art. Amain body 112 of an electronic apparatus 110 has a recess 112a and a through hole 113, as shown in FIG. 3. In the push button 200, a shaft 224 of an operation body 222 passes through the through hole 113. The gap between the through hole 113 and the shaft 224 forms an accommodation chamber 113a, and two annular gaskets 230 are disposed in the accommodation chamber 113a. The opening of the accommodation chamber 113a on the side facing the operation body 222 is closed with a lid section 242 of a lid body 240.

The lid body 240 of the related art is formed of a tubular insertion section 242a, which is inserted into the accommodation chamber 113a, and the annular lid section 242, which extends from the insertion section 242a to forma flange. A coil spring 250, which is so disposed as to surround the shaft 224, not only urges the lid body 240 toward a placement surface 112d of the main body 112 but also urges the operation body 222 in the direction away from the lid body 240.

The thus configured push button 200 of the related art is required to meet a market demand that the amount of protrusion of the pushbutton 200 from the electronic apparatus 110 should be reduced from viewpoints of operability and portability of the electronic apparatus 110 used by a user and other reasons. It is, however, difficult to reduce the amount of protrusion of the push button 200 with the travel stroke thereof in the protruding/retracting direction A unchanged.

### 2-2. Push Button According to Present Embodiment

The push button 20a according to the present embodiment will next be described with reference to FIG. 2. Each of the push buttons 20b, 20c, 20d, and 20e has basically the same configuration as that of the push button 20a and will therefore not be described.

The push button 20a includes an operation body 22, a lid body 40, and a spring 50, as shown in FIG. 2. The operation body 22 has a first surface (hereinafter referred to as “inner surface 22b”). The lid body 40 includes a lid section 42, a reception section 46, which is so disposed to be more remote from the inner surface 22b than the lid section 42, and a trunk section 44, which connects the lid section 42 and the reception section 46 to each other. The spring 50 is disposed between the operation body 22 and the lid body 40 and has one end 51 and the other end 52 in a direction that intersects the inner surface 22b of the operation body 22 with the one end in contact with the reception section 46 and the other end in contact with the inner surface 22b. The state in which the spring 50 is in contact with the reception section 46 and the inner surface 22b includes a state in which the spring is in direct or indirect contact with the ends, that is, another member may be interposed between the spring 50 and reception section 46 or the inner surface 22b.

The operation body 22 can protrude and retract relative to the main body 12 of the electronic apparatus 10. The lid body 40 can restrict movement of the gaskets 30, which are disposed in the main body 12, toward the operation body 22. The spring 50 is disposed between the operation body 22 and the lid body 40 and urges the operation body 22 in the direction away from the lid body 40. The gaskets 30 are sandwiched between the lid section 42 of the lid body 40 and the main body 12. The trunk section 44 of the lid body 40 extends from the lid section 42 toward the main body 12. The reception section 46 of the lid body 40 protrudes from the trunk section 44 in a direction that intersects the protruding/retracting direction A of the operation body 22.

According to the thus configured push button 20a, since the reception section 46 of the lid body 40 is so disposed to be more remote from the inner surface 22b of the operation body 22 than the lid section 42 and is in contact with the one end 51 of the spring 50, the amount of protrusion, from the main body of the apparatus, of the push button 20a assembled in the main body can be reduced, as compared, for example, with a case where the one end of the spring is in contact with the lid section. In particular, according to the push button 20a, the spring 50 can be disposed inside the main body 12, unlike the push button 200 of the related art shown in FIG. 3, whereby a small amount of protrusion from the main body 12 is achieved.

The portions of the push button 20a will be described below in detail.

The operation body 22 has an outer surface 22a, which is pushed by the user, and the inner surface 22b, which is the first surface opposite the outer surface 22a. The inner surface 22b is in contact with the other end 52 of the spring 50 in the direction that intersects the inner surface 22b. The direction that intersects the inner surface 22b is more preferably a direction substantially perpendicular to the inner surface 22b and is, for example, the protruding/retracting direction A. The operation body 22 is made of a plastic material, which excels in lightness and manufacturability, but may instead be made of a metal.

The operation body 22 further has an annular wall section 22c, which extends from the operation body 22 toward the main body 12. The annular wall section 22c is provided along the outer edge of the operation body 22, and the outer side surface of the wall section 22c is disposed along the opening 12b of the recess 12a provided in the main body 12 with a slight gap between the wall section 22c and the opening 12b. That is, the wall section 22c surrounds the inner surface 22b. The outer side surface of the wall section 22c may instead be in contact with the opening 12b and slide relative to the opening 12b when the operation body 22 is moved in the protruding/retracting direction A. The wall section 22c only needs to substantially surround the inner surface 22b and may have a seamlessly annular shape or may be formed of two or more walls that are not connected to each other.

The recess 12a of the main body 12 accepts the lid body 40, the spring 50, and at least part of the wall section 22c of the operation body 22.

The inner side surface of the wall section 22c restricts movement of the spring 50 in the direction perpendicular to the protruding/retracting direction A. Since the wall section 22c stably keeps the positional relationship between the spring 50 and the operation body 22 in the direction perpendicular to the protruding/retracting direction A, the operation body 22 is allowed to move in a stable manner along the protruding/retracting direction A. In particular, even when the size of the operation body 22 is increased and the spring 50 is therefore disposed in a position remote from the shaft 24, the spring 50 is unlikely to move in the direction perpendicular to the protruding/retracting direction A or incline thereto. Further, in the process of assembling the push button 20a in the main body 12, the inner side surface of the wall section 22c can readily guide the spring 50 to a predetermined position, whereby the workability can be improved.

The wall section 22c extends from the outer edge of the operation body 22 toward the main body 12. Since the wall section 22c extends from the outer edge and the spring 50 is disposed inside the wall section 22c, the spring 50 is unlikely to incline even when the user pushes the outer edge or therearound. The inner side surface of the wall section 22c may be formed in accordance with the outer shape of the spring 50. For example, when the spring 50 is a coil spring, a cylindrical wall section 22c having an inner diameter slightly greater than the outer diameter of the coil may be employed. Further, the inner side surface of the wall section 22c may be provided with proj ections and depressions that are partially in contact with part of the outer circumference of the spring 50.

Further, an annular groove may be formed in the inner surface 22b, and the other end 52 of the spring 50 may be disposed in the groove. In this case, even when the winding diameter of the spring 50 is so small that the spring 50 does not come into contact with the wall section 22c, for example, the spring 50 can be readily disposed in a predetermined position when the spring 50 is assembled.

The shaft 24 is so disposed that the longitudinal direction thereof coincides with the direction that intersects the inner surface 22b. The shaft 24 extends from the operation body 22 into the main body 12 along the protruding/retracting direction A. The shaft 24 passes through the through hole 13 provided in the main body 12 and has one end fixed to and integrated with the operation body 22 and the other end present in the main body 12. A fastener 26 is fastened to the other end of the shaft 24 and comes into contact with the inner surface of the main body 12 to restrict movement of the shaft 24 in the retracting direction of the operation body 22. The fastener 26 is a known E-shaped or C-shaped snap ring or a snap ring having any other shape. The shaft 24 is made of a metal and joined with the plastic operation body 22 in an insert-molding process. When the operation body 22 is made of a metal, the shaft 24 may be part of the operation body 22.

Each of the gaskets 30 is an annular body made of a rubber or plastic material and maintains predetermined airtightness in the through hole 13 so that the interior of the main body 12 is sealed from the exterior thereof. Each of the gaskets 30 may instead be an O ring made of a rubber material. The gaskets 30 are accommodated in an accommodation chamber 13a provided in the main body 12 with the shaft 24 inserted through the inner holes of the gaskets 30. The accommodation chamber 13a is part of the through hole 13 and has an inner diameter greater than the outer diameter of the shaft 24. The accommodation chamber 13a is open toward the operation body 22 with the shaft 24 inserted through the accommodation chamber 13a and accepts an insertion section 42a of the lid body 40.

The lid body 40 includes the lid section 42, the reception section 46, which is so disposed to be more remote from the inner surface 22b than the lid section 42, and the trunk section 44, which connects the lid section 42 and the reception section 46 to each other. The lid body 40 is an annular body that surrounds the shaft 24 when viewed in the longitudinal direction. The lid body 40 includes the lid section 42, which holds the gaskets 30 in such a way that the lid section 42 and the main body 12 sandwich the gaskets 30, the trunk section 44, which extends from the lid section 42 toward the main body 12, and the reception section 46, which protrudes from the trunk section 44 in the direction that intersects the protruding/retracting direction A of the operation body 22.

The outer edge of the lid section 42 connects with the trunk section 44. The lid section 42 has one surface in contact with a placement surface 12d, which forms the opening of the through hole 13, and further has the insertion section 42a, which has a tubular shape (cylindrical shape, for example) and extends from the inner edge of the one surface toward the gaskets 30.

The trunk section 44 has a tubular shape (cylindrical shape, for example), and the outer circumferential surface of the trunk section 44 restricts movement of the spring 50 in the direction perpendicular to the protruding/retracting direction A. The outer circumferential surface of the trunk section 44 is slightly smaller than the inner diameter of the spring 50. The outer circumferential surface of the trunk section 44, which extends from the lid section 42 toward the main body 12, can support the inner side of the spring 50 and can therefore more reliably restrict the movement of the spring 50 in the direction perpendicular to the protruding/retracting direction A.

The reception section 46 is a flange-shaped portion having an inner edge connected to the trunk section 44. The reception section 46, specifically, the surface thereof facing the inner surface 22b of the operation body 22 is in contact with the one end 51 of the spring 50. Since the fastener 26 restricts the movement of the shaft 24 in the retracting direction of the operation body 22, urging force of the spring 50 presses the lid section 42 toward the main body 12 (placement surface 12d) and the operation body 22 in the retracting direction. The insertion section 42a of the lid section 42 therefore keeps holding the gaskets 30 in the accommodation chamber 13a.

The spring 50 is, for example, a coil spring made of a metal and surrounding the shaft 24 and the lid body 40. The arrangement in which the annular lid body 40 and the spring (coil spring) 50 surround the shaft 24 hardly inclines the shaft 24 and therefore allows the operation body 22 and the shaft 24 to move in the protruding/retracting direction A in a stable manner. The spring 50 has a winding diameter greater than the diameter of the push button 200 of the related art and urges a portion of the operation body 22 in the vicinity of the outer edge thereof, whereby the operation body 22 is unlikely to incline to the protruding/retracting direction A, and the operation body 22 can be stably urged along the protruding/retracting direction A even when the size of the operation body 22 is increased (even when the surface area of the outer surface 22a is increased). The spring 50 may instead be any other known annular spring. The material of the spring 50 may be chosen as appropriate in accordance with application.

### 3. Variation 1

A push button 20f according to Variation 1 will be described with reference to FIG. 4. FIG. 4 is a cross-sectional view of the push button 20f according to Variation 1 taken along the line X-X in FIG. 1. In FIG. 4, the same components as those of the push button 20a in FIG. 1 have the same reference characters, and no description that overlaps with the description of the push button 20a will be made below.

The lid body 40 is so configured that the lid section 42 has no insertion section 42a and has a simple disk shape, as shown in FIG. 4. Since the lid section 42 has no insertion section 42a, the recess 12a can be formed to a deeper level in the main body 12 accordingly. The amount of protrusion of the push button 20f from the main body 12 can therefore be further smaller than that of the push button 20a.

### 4. Variation 2

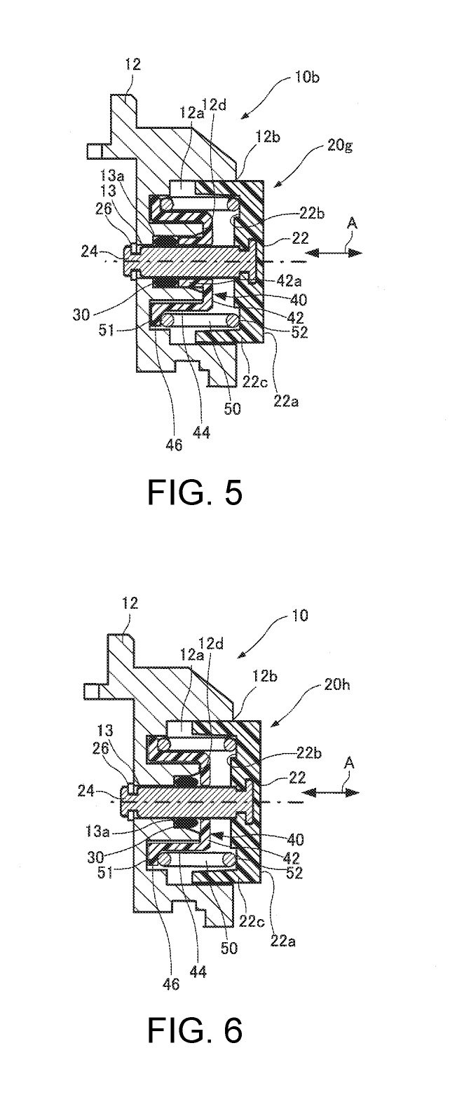

A push button 20g according to Variation 2 will be described with reference to FIG. 5. FIG. 5 is a cross-sectional view of the pushbutton 20g according to Variation 2 taken along the line X-X in FIG. 1. In FIG. 5, the same components as those of the push button 20a in FIG. 1 have the same reference characters, and no description that overlaps with the description of the push button 20a will be made below.

The number of gaskets 30 is changed to one, and the accommodation chamber 13a can be shortened in the protruding/retracting direction A accordingly, whereby the recess 12a can be formed to a deeper level in the main body 12, as shown in FIG. 5. The amount of protrusion of the push button 20g from the main body 12 can therefore be further smaller than that of the push button 20a.

### 5. Variation 3

A push button 20h according to Variation 3 will be described with reference to FIG. 6. FIG. 6 is a cross-sectional view of the pushbutton 20h according to Variation 3 taken along the line X-X in FIG. 1. In FIG. 6, the same components as those of the push button 20a in FIG. 1 have the same reference characters, and no description that overlaps with the description of the push button 20a will be made below.

The number of gaskets 30 is changed to one, and the lid section 42 has no insertion section 42a, as shown in FIG. 6. The accommodation chamber 13a can be shortened in the protruding/retracting direction A accordingly, whereby the recess 12a can be formed to a deeper level in the main body 12. The amount of protrusion of the push button 20h from the main body 12 can therefore be further smaller than that of the push button 20a.

The electronic apparatus 10, 10a, and 10b of each of the embodiment and the variations described above is a wristwatch-shaped electronic apparatus in the present embodiment, but the invention is not limited to a wristwatch-shaped electronic apparatus and is applicable to a push button of any other known electronic apparatus as appropriate. Further, the operation body 22 has the outer surface 22a directly pushed by the user, and the outer surface 22a may, for example, be covered with a decorative cover.

The invention is not limited to the embodiment described above, and a variety of changes can be further made thereto. For example, the invention encompasses substantially the same configuration as the configuration described in the embodiment (for example, a configuration having the same function, using the same method, and providing the same result or a configuration having the same purpose and providing the same effect). Further, the invention encompasses a configuration in which an inessential portion of the configuration described in the embodiment is replaced. Moreover, the invention encompasses a configuration that provides the same advantageous effect as that provided by the configuration described in the embodiment or a configuration that can achieve the same purpose as that achieved by the configuration described in the embodiment. Further, the invention encompasses a configuration in which a known technology is added to the configuration described in the embodiment.

What is claimed is:

1. A push button comprising:
an operation body having a first surface;
a lid body including a lid section, a reception section so disposed to be more remote from the first surface than the lid section, and a trunk section that connects the lid section and the reception section; and
a spring that is disposed between the operation body and the lid body and has one end and another end in a direction that intersects the first surface of the operation body with the one end in contact with the reception section and the other end in contact with the first surface.

2. The push button according to claim 1,
wherein the operation body includes a wall section that surrounds the first surface.

3. The push button according to claim 1, further comprising
a shaft having a longitudinal direction that coincides with the intersecting direction,
wherein the spring is a coil spring that surrounds the shaft, and
the lid body is an annular body that surrounds the shaft when viewed in the longitudinal direction.

4. An electronic apparatus comprising:
a push button including
an operation body having a first surface,
a lid body including a lid section, a reception section, and a trunk section that connects the lid section and the reception section, and
a spring that is disposed between the operation body and the lid body and has one end and another end in a direction that intersects the first surface of the operation body with the one end in contact with the reception section and the other end in contact with the first surface.
